(19) United States
(12) Patent Application Publication
(10) Pub. No.: US 2020/0086800 A1
(43) Pub. Date: Mar. 19, 2020

(54) SIDE MOUNT CARGO HOLDER FOR TRUCK BEDS

(71) Applicant: Gregory Gene Boelter, East Bethel, MN (US)

(72) Inventor: Gregory Gene Boelter, East Bethel, MN (US)

(21) Appl. No.: 16/550,722

(22) Filed: Aug. 26, 2019

Related U.S. Application Data
(60) Provisional application No. 62/730,812, filed on Sep. 13, 2018.

(51) Int. Cl. B60R 9/02; B62D 33/02

(52) U.S. Cl. CPC B60R 9/02; B62D 33/0207

(57) ABSTRACT

An elongated cargo holder formed from a durable yet flexible sheet of mesh-like material that is foldable in half to form two opposing sides of the holder with open ends, wherein each side of the cargo holder includes grommeted openings that are constructed for releasable connection to a series of corresponding toggle fasteners mounted to the bed of a truck along one or both sides thereof. The cargo holder is constructed to fasten along the top inside surface of the side of a truck bed, such that it will suspend cargo contained therein just above the wheel well of the truck and away from the floor of the truck bed.

### CROSS REFERENCE TO RELATED APPLICATIONS

This application is a nonprovisional application which claims the benefit of U.S. Provisional Application Ser. No. 62/730,812, filed on Sep. 13, 2018, the contents of which is hereby incorporated herein in its entirety by reference thereto.

### FIELD OF INVENTION

The present invention relates generally to the field of cargo storage devices for use in connection with truck beds, and more specifically to storage devices constructed in the form of a durable cargo holder that is conveniently securable to the sides of a truck bed in an out-of-the-way yet readily accessible location.

### BACKGROUND

The statements in this section merely provide background information related to the present disclosure and may not constitute prior art.

Organized storage of tools and other cargo in the bed of a truck for more efficient and convenient access when needed continues to be a difficult and nagging problem for construction workers, homeowners and the like. Smaller tools left open in the bed of a truck generally become covered with other larger cargo, thus making them difficult to access and easy to damage during transport. Free movement of such items in the truck bed also makes it difficult for the operator to locate and reach the smaller items when needed.

Attempts have been made previously to section off various portions of a truck bed with netting devices for storage of small and large cargo. Most of these netting devices are made to extend across the bed of a truck such that the tools or other cargo being transported will be contained to the front or rear of the truck bed. One such cargo net is disclosed in U.S. Pat. No. 8,192,118. While such nets are somewhat effective in providing a more organized, expandable storage area for tools, etc., the stowed items still take up significant space within the main area of the truck bed and are susceptible to damage from the continual jarring and vibration caused by the truck bed during transport, or by significantly larger, heavier cargo that is being transported at the same time.

Therefore, it is evident that there is a need for a truck bed storage device which is conveniently located in an out-of-the-way safe location to prevent damage to the stowed items, and which is readily accessible for easy access thereto, as necessary. It is with this objective in mind, and more, that I have developed our improved side mount cargo holding storage device for truck beds, as will be described in more detail below.

### SUMMARY

In furtherance of the foregoing objectives, the present invention is comprised generally of an elongated cargo holder which is formed from a durable yet flexible mesh-like material, and which is foldable in half and constructed for releasable connection to the bed of a truck along one or both sidewalls thereof. More specifically, it is contemplated that the cargo holder may be constructed from a single sheet of durable plastic mesh material, including without limitation, a UV treated polyethylene mesh that is tear and mildew resistant. This mesh sheet is very flexible in nature, and may be readily folded in half to form a general V-like cradle structure having a supporting bottom surface, opposing front and back mesh side panels, and open ends. In one preferred embodiment, the mesh sheet may be appropriately dimensioned such that, when folded in half, the supporting bottom surface thereof is seated within the truck bed just above the side wheel well of the truck.

The top edge portion of each opposing side panel of the cargo holder includes multiple spaced grommeted openings extending along the length thereof. The grommets on one side of the mesh sheet are positioned for alignment with the grommets on the opposing side of the mesh sheet when the sheet is folded in half. A set of releasable mechanical connectors, such as T-toggle type stainless steel fasteners, may then be secured along the top inside surface of either sidewall of the truck bed, in cooperatively spaced alignment with the grommeted openings in the cargo holder. These connectors are appropriately sized to receive in locking relation the grommets of each side of the cargo holder. Both sides of the cargo holder may then be secured to the connectors on the sidewall of the truck bed, thus providing a conveniently accessible cargo holder to store necessary tools, equipment and other smaller essentials that would otherwise slide around the truck bed.

With both ends of the cargo holder being open, longer items may be slid in and out of the confines of the cargo holder without undoing any of the connectors. However, if desired, any one or more grommeted openings of the inner side of the cargo holder may be released from its connector with ease to expose a larger portion of the inner confines of the cargo holder. This increases visibility, thus helping to locate any tool or other cargo being stowed therein. With the cargo holder being constructed to fit along either sidewall of the truck bed, just above the truck's wheel wells, tools contained therein are readily accessible and suspended above the floor of the truck bed during transport. Thus, the contents of the cargo holder are effectively protected from sliding around the truck bed, or from being damaged due to the jarring and vibration of the moving vehicle.

The foregoing and additional features and advantages of the present invention will be more readily apparent from the following detailed description. It should be understood, however, that the description and specific examples herein are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view showing one exemplary embodiment of a side mount cargo holder constructed in accordance with the present invention installed on the inner side surface of a truck bed;

FIGS. 2A-2C are diagrammatic representations of three different possible sizes of the side mount cargo holder of the present invention configured for different sized truck beds;

FIG. 3 is a side elevational view of a T-toggle mechanical connector used to secure the cargo holder as shown in FIG. 1 to the sidewall of a truck bed;

FIG. 4A is a side elevational view of an alternative releasable and movable mount with a T-toggle connector, for use in non-drill or less permanent cargo storage applications; and

FIG. 4B is a perspective view of the non-permanent T-toggle connector mount shown in FIG. 4A attached to the sidewall of a truck bed.

### DETAILED DESCRIPTION

The following description is merely exemplary in nature and is not intended to limit the present disclosure, application, or uses. It should be understood that throughout the drawings, corresponding reference numerals indicate like or corresponding parts and features.

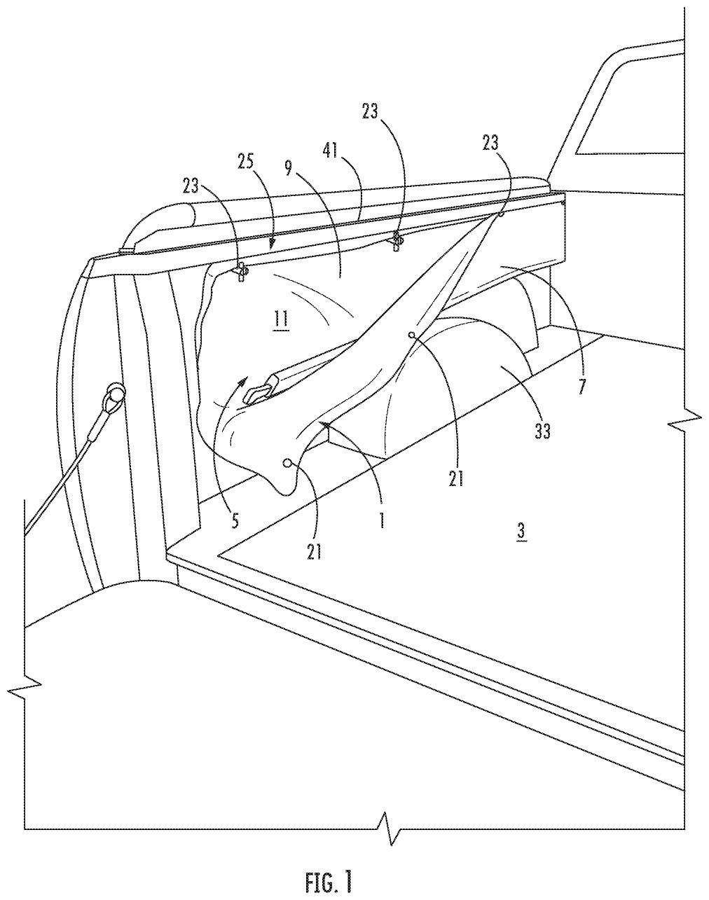

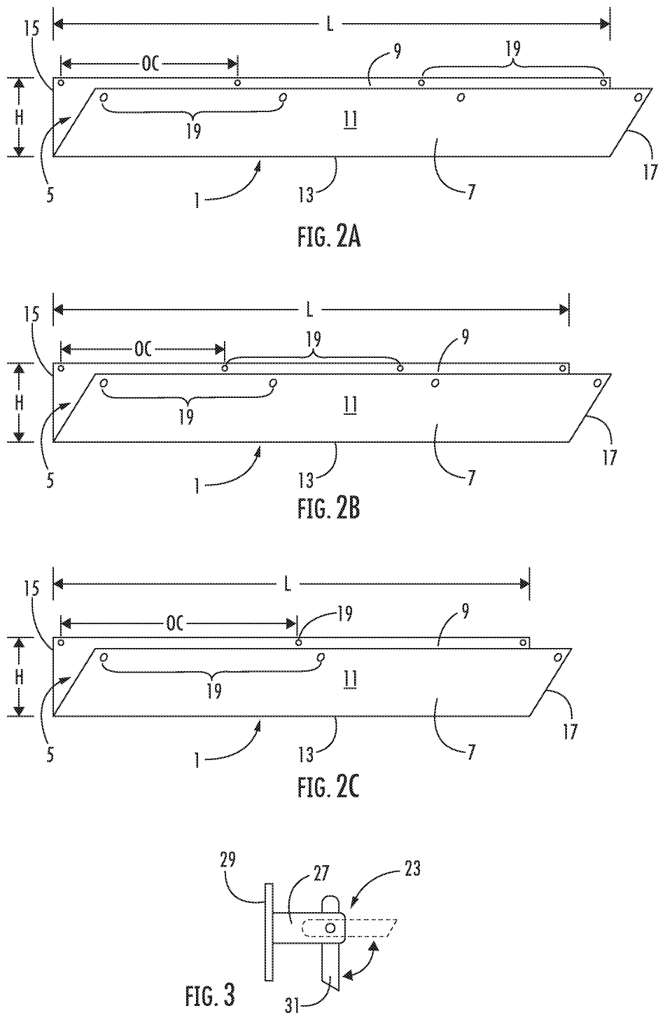

With reference now to FIGS. 1 through 2C of the drawings, an exemplary embodiment is shown of an elongated side mount truck cargo holder 1 constructed in accordance with the present invention. The cargo holder 1 is specifically designed to be secured to one of the sidewalls 2 of a truck bed 3. Since it is well known that the truck beds 3 of various manufactures may be produced in a number of different sizes and configurations, it is conceivable that the cargo holder 1 may also be manufactured in multiple sizes/lengths to fit the various different size truck beds. Accordingly, three different exemplary sizes of the cargo holder 1 are shown in FIGS. 2A-2C.

As shown, cargo holder 1 is a foldable net-like storage device designed for use in a truck bed 3. The cargo holder 1 comprises, in general, a one-piece storage receptacle having a flexible front side panel 7 and opposing flexible back side panel 9 which defines a storage area 5 therebetween. In the embodiment shown, the cargo holder 1 is formed from a single sheet 11 of durable plastic mesh material, such as 5.8 oz. polyethylene mesh fabric, which is tear and mildew resistant, and has been chemically formulated with UV sun protection. The mesh sheet 11 is very flexible in nature, and may be readily folded in half such that the opposing front and back side panels 7 and 9 of the holder 1 form a general V-like cradle structure with a supporting bottom surface 13, and open ends 15 and 17.

The top edge portion of each opposing side panel 7 and 9 of the cargo holder 1 includes multiple spaced openings 19 extending along the length thereof. Each opening 19 incorporates a reinforcing grommet 21 formed of a substantially rust-proof material, such as brass or stainless steel. As shown, a grommeted opening 19 is positioned along the top edge of each opposing side panel 7 and 9 of the cargo holder 1, closely adjacent the opposite open ends 15 and 17 thereof. Depending on the length of the truck bed 3, the cargo holder 1 can be sized to fit within the truck bed 3, with one opening 19 located adjacent each opposite end 15 and 17 or the cargo holder 1, and one or more grommeted openings 19 located therebetween. For example, as shown in FIG. 2A, for a cargo holder 1 having a length L of about 7.0 feet, it is contemplated that a series of four (4) grommeted openings 19 may be equally spaced at approximately 27.0 inches OC (on-center) along the length thereof (i.e., leaving a small portion of material at each end). As depicted in FIGS. 2B and 2C, other exemplary dimensions for different length cargo holders 1 are also contemplated; therefore, it is certainly conceivable that more or less grommeted openings 19 may be provided without departing from the scope of the invention herein.

As will be described in more detail hereafter, and best shown in FIG. 1, the grommeted openings 19 function as a means for securing the cargo holder 1 to the sidewall 2 of a truck bed 3. Toward this end, as seen in FIG. 1, a set of releasable mechanical connectors 23, such as T-toggle type stainless steel fasteners, may be secured along the top inside surface 25 of either sidewall 2 of the truck bed 3. As shown best in FIG. 3, each connector 23 is constructed with a stainless steel shank 27 and a mounting plate 29 that may be secured via bolts or screws to one of the upper inner sidewall surfaces 25 adjacent the top side rail 41 of the truck bed 3. A stainless steel tongue 31 is pivotally mounted to the shank 29, such that it may swivel in a vertical plane between a generally horizontal extended position and a locking “T” vertical fastening position.

As shown best in FIG. 1, the T-toggle connectors 23 are mounted to the inside sidewall surface 25 of the sidewall 2 of the truck bed 3 in cooperatively spaced alignment with the grommeted openings 19 of the cargo holder 1. Also, as seen in FIGS. 1 and 2, when the mesh sheet 11 is folded in half to form cargo holder 1, the grommeted openings 19 located on the front side panel 7 are positioned for alignment with the grommeted openings 19 on the opposing back side panel 9. Accordingly, these T-toggle connectors 23 are appropriately sized to receive in locking relation the grommeted openings 19 of both sides 7 and 9 of the cargo holder 1.

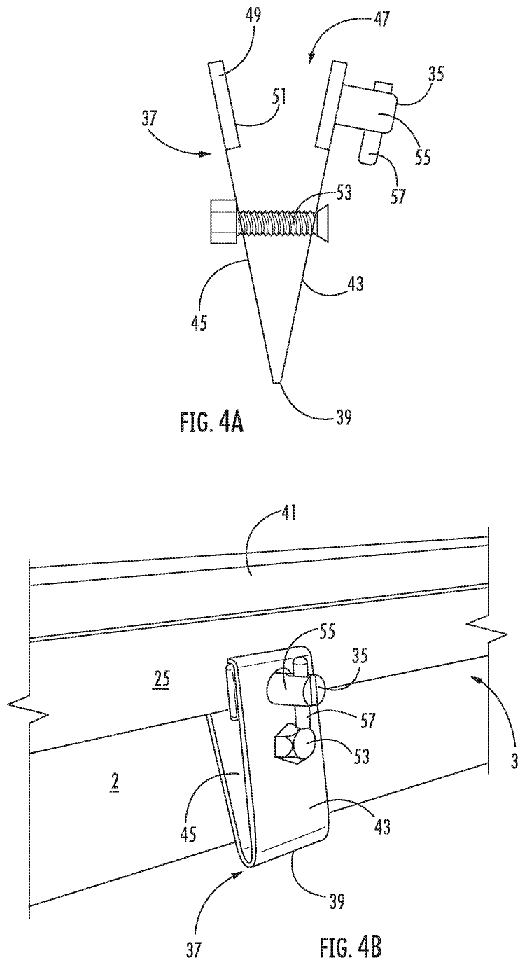

As shown in FIGS. 4A and 4B, a similar T-toggle connector assembly 35 may alternatively be affixed to a readily releasable and movable mounting fixture 37 for use in non-drill or less permanent cargo storage applications. The use of such a mounting fixture 37 requires no modification to the sidewall 2 of the truck bed 3. In this embodiment, the mounting fixture 37 is in the form of a spring steel V-clamp 39 which is adapted to be secured to the inner surface 25 of a truck bed sidewall 2, adjacent to the top side rail 41 of the truck bed.

As shown, the T-toggle connector 35 is fixedly secured to the inner leg 43, adjacent the mouth 47 of the adjustable V-clamp 39, facing the interior of the truck bed 3. The opposite leg 45 of the V-clamp 39 may include a padding 49, such as a small plastic or foam protective cushion, which bears against the back side of the surface 25 of the sidewall 2 to which it is connected. This padding 49 may be secured adjacent the mouth 47 of the V-clamp 39 via an adhesive or any other suitable means. The padding 49 may also include an adhesive on its inner face 51 to help secure the V-clamp 37 to the sidewall 2 of the truck bed 3. Of course, it is contemplated that a similar padding 49 could also be provided on the opposite leg 43 of the V-clamp 39, without departing from the invention herein.

A tightening bolt 53 extending between the opposing legs 43 and 45 can be used to tighten or loosen the grip of the mounting fixture 37 upon the surface 25 of the truck bed sidewall 2, as desired. The mounting fixture 37 can be removed, transferred and used between multiple differently sized truck beds, as necessary of desired. Here again, it is certainly contemplated that mounting fixture 37 could take on other forms of a releasable and movable mounting mechanism, without departing from the invention herein.

The T-toggle connector 35 carried upon mounting fixture 37 is constructed and functions in the same manner as the T-toggle connector 23 shown in FIG. 3. As shown, a set of such connectors 35 may be secured as described via adjustable mounts 37 to the inner surface 25 of a truck bed sidewall 2. Each connector 35 is constructed with a stainless steel shank 55 and a stainless steel tongue 57 pivotally attached thereto, such that the tongue 57 may swivel in a vertical plane between a generally horizontal extended position and a locking “T” vertical fastening position (as shown in FIG. 4A).

To form cargo holder 1 and secure the same to the sidewall 2 of the truck bed 3, a user simply toggles the tongue (31, 57) of each connector (23, 35) to its extended horizontal position, and then slides an aligned grommeted opening 19 of the back side panel 9 there over. Pivoting the tongue (31,57) of each connector to its vertical fastening position will then lock the back side panel 9 to the sidewall 2 of the truck bed 3 (as shown in FIG. 2). With the back side panel 9 secured, the sheet 11 may then be folded in half to form the front side panel 7 of the cargo holder 1. The correspondingly aligned grommeted openings 19 located on the front side panel 7 of the cargo holder 1 may then be fastened to the connectors (23, 35) in the same manner as described above. Accordingly, both side panels 7 and 9 of the cargo holder 1 may be secured to the connectors (23, 35) on the sidewall 2 of the truck bed 3, thus providing a conveniently accessible storage area for tools, equipment and other smaller essentials that would otherwise slide around in the truck bed 3 and potentially become damaged.

With both ends 15 and 17 of the cargo holder 1 being open, longer items may be slid in and out of the confines 5 of the cargo holder 1 without undoing any of the connectors (23, 35). However, if desired, any one or more grommeted openings 19 of the front side panel 7 of the cargo holder 1 may be easily released from its connector (23, 35) to expose a larger portion of the inner confines 5 of the cargo holder 1 (as shown in FIG. 2). This increases visibility, thus helping to locate any tool or other cargo being stowed therein.

As further shown in FIGS. 1 and 2, in a preferred embodiment, the mesh sheet 11 may be appropriately dimensioned such that, when folded in half, the supporting bottom surface 13 thereof is seated within the truck bed 3 just above the side wheel well 33 of the truck. While not intending to limit the present disclosure in any way, it is contemplated that sheet 11 could be dimensioned such that the height H of side panels 7 and 9, and consequently the depth of the storage area 5, is approximately twelve (12) inches. In this manner, the cargo holder 1 can effectively fit in an out-of-the-way location along either sidewall 2 of the truck bed 3, just above the wheel well 33, such that tools or other items contained therein are readily accessible and suspended above the floor of the truck bed 3 during transport. Thus, the contents of the cargo holder 1 are effectively protected from sliding around the truck bed, and from being damaged due to the jarring and vibration caused by the floor of the truck bed during transport.

The disclosure herein is intended to be merely exemplary in nature and, thus, variations that do not depart from the gist of the disclosure are intended to be within the scope of the disclosure. Such variations are not to be regarded as a departure from the spirit and scope of the disclosure, which comprises the matter shown and described herein, and set forth in the appended claims.

1. A side mount cargo storage holder for the bed of a truck, comprising:
(a) a truck bed container having a bed floor, a pair of sidewalls, a front wall and a rear wall, each of said sidewalls extending a predetermined height from said bed floor to a top sidewall edge;
(b) a plurality of toggle connectors mounted in spaced relation to at least one of said sidewalls adjacent said top sidewall edge thereof, at least some of said toggle connectors including a pivotable tongue member which is capable of movement between an open position and a locking position;
(c) a receptacle for holding cargo, said receptacle being formed of a single sheet of pliable, durable material which is foldable in half to define opposing front and back side panels of said receptacle, a supporting bottom surface, and open ends;
(d) each of said opposing front and back side panels of said receptacle having a set of reinforced openings extending there through which align with said openings on said opposite side panel of said receptacle when said sheet of material is folded in half, said openings on said front side and said back side panels of said receptacle being spaced between said opposing open ends in cooperatively aligned relation with said toggle connectors mounted on said at least one of said sidewalls of said truck bed container;
(e) said toggle connectors in said open position being constructed to extend through said aligned openings in said front side panel and said back side panel of said receptacle when said sheet of material is folded in half, and to toggle to said locking position to retain said receptacle securely against said truck bed sidewall upon which said toggle connectors are mounted; and
(f) said openings in said front and said back side panels of said receptacle being positioned such that said supporting bottom surface of said receptacle is suspended in an elevated position relative to said bed floor of said truck bed container.

2. The side mount cargo storage holder set forth in claim 1, wherein said sheet of material is formed of a plastic mesh.

3. The side mount cargo storage holder set forth in claim 2, wherein said plastic material is comprised of a polyethylene mesh which is tear and mildew resistant, and has been chemically formulated with UV sun protection.

4. The side mount cargo storage holder set forth in claim 1, wherein said receptacle extends substantially the entire length of said sidewall to which it is attached, between said front wall and said rear wall of said truck bed container.

5. The side mount cargo storage holder set forth in claim 1, wherein said sidewall of said truck bed to which said receptacle is attached includes a wheel well protruding inward into said bed container, and said openings in said front and said back side panels of said receptacle are positioned such that said supporting bottom surface of said receptacle will be suspended in an elevated position relative to a top surface of said wheel well.

6. The side mount cargo storage holder set forth in claim 1, wherein said openings in said front and said back side panels of said receptacle are positioned closely adjacent an upper edge of said receptacle.

7. The side mount cargo storage holder set forth in claim 1, wherein said tongue of each of said toggle connectors is readily movable between said open position and said locking position to allow easy access within said receptacle.

8. The side mount cargo storage holder set forth in claim 1, wherein said open ends of said receptacle face said front wall and said rear wall of said truck bed container, respectively.

9. The side mount cargo storage holder set forth in claim 1, wherein said toggle connectors are constructed as non-permanent clamping mechanisms which are securable to said sidewalls of said truck bed container without modification of said sidewalls.

10. The side mount cargo storage holder set forth in claim 1, wherein said tongue of each of said toggle connectors is pivotable between a substantially horizontal open position and a substantially vertical locking position.

11. The side mount cargo storage holder set forth in claim 1, wherein said openings in said receptacle include reinforcing grommets which are secured to said sheet and define said openings.

12. The side mount cargo storage holder set forth in claim 1, wherein the length of said front and back sides of said receptacle between a top edge of said openings and said supporting bottom surface is less than said predetermined height from said bed floor to said top sidewall edge of said truck bed container.

13. A side mount cargo storage holder for the bed of a truck, comprising:
(a) a truck bed container having a bed floor, a pair of sidewalls, a front wall and an openable rear tailgate wall;
(b) a plurality of toggle T-connectors mounted in spaced relation to at least one of said sidewalls adjacent a top sidewall edge thereof, said toggle T-connectors including a pivotable tongue member which is capable of movement between a generally horizontal open position and a generally vertical locking position;
(c) a receptacle for holding cargo, said receptacle being formed of a single sheet of pliable, durable plastic mesh material which is foldable in half to define opposing front and back side panels of said receptacle, a supporting bottom surface, and open ends;
(d) each of said opposing front and back side panels of said receptacle having a plurality of grommeted openings extending there through which are spaced between said opposing open ends of said receptacle in cooperatively aligned relation with said toggle T-connectors mounted on said sidewalls of said truck bed container;
(e) said toggle T-connectors in said open position being constructed to extend through said openings in said front side panel and said back side panel of said receptacle, and to toggle to said locking position to retain said receptacle against said truck bed sidewall upon which said toggle T-connectors are mounted; and
(f) said receptacle extending substantially the full length of said truck bed container between said front wall and said openable rear tailgate wall, with one of said open ends of said receptacle being positioned adjacent said openable rear tailgate wall.

14. The side mount cargo storage holder set forth in claim 13, wherein said openings in said front and said back side panels of said receptacle are positioned such that said supporting bottom surface of said receptacle is suspended in an elevated position relative to said bed floor of said truck bed container.

15. The side mount cargo storage holder set forth in claim 14, wherein said openings in said front and said back side panels of said receptacle are positioned closely adjacent an upper edge of said receptacle.

16. The side mount cargo storage holder set forth in claim 13, wherein said sidewall of said truck bed to which said receptacle is attached includes a wheel well protruding inward into said bed container, and said openings in said front and said back side panels of said receptacle are positioned such that said supporting bottom surface of said receptacle will be suspended in an elevated position relative to a top surface of said wheel well.

17. The side mount cargo storage holder set forth in claim 13, wherein said toggle T-connectors are constructed as non-permanent clamping mechanisms which are securable to said sidewalls of said truck bed container without modification of said sidewalls.

18. The side mount cargo storage holder set forth in claim 13, wherein said plastic mesh material of said receptacle is comprised of a polyethylene mesh which is tear and mildew resistant, and has been chemically formulated with UV sun protection.

19. A side mount cargo storage holder for the bed of a truck, comprising:
(a) a truck bed container having a bed floor, a pair of sidewalls, a front wall and an openable rear tailgate wall, each of said sidewalls of said truck bed having a wheel well protruding inward into said bed container;
(b) a plurality of toggle connectors mounted in spaced relation to at least one of said sidewalls adjacent a top sidewall edge thereof, said toggle connectors including a pivotable tongue member which is capable of movement between an open position and a locking position;
(c) a receptacle for holding cargo, said receptacle being formed of a single sheet of pliable, durable plastic mesh material which is foldable in half to define opposing front and back side panels of said receptacle, a supporting bottom surface, and open ends;
(d) each of said opposing front and back side panels of said receptacle having a plurality of reinforced openings extending there through which are spaced between said opposing open ends of said receptacle in cooperatively aligned relation with said toggle connectors mounted on said sidewalls of said truck bed container;
(e) said toggle connectors in said open position being constructed to extend through said openings in said front side panel and said back side panel of said receptacle, and to toggle to said locking position to retain said receptacle against said truck bed sidewall upon which said toggle connectors are mounted;
(f) said openings in said front and said back side panels of said receptacle being positioned such that said supporting bottom surface of said receptacle is suspended in an elevated position relative to a top surface of said wheel well which protrudes from said truck bed sidewall upon which said toggle connectors are mounted; and
(g) said receptacle extending substantially the full length of said truck bed container between said front wall and said openable rear tailgate wall, with one of said open ends of said receptacle being positioned adjacent said openable rear tailgate wall.

20. The side mount cargo storage holder set forth in claim 13, wherein each of said sidewalls of said truck bed container have said toggle connectors mounted adjacent a top sidewall edge thereof and carry a separate said receptacle for cargo thereon.
